(19) United States
(12) Patent Application Publication
(10) Pub. No.: US 2014/0107847 A1
(43) Pub. Date: Apr. 17, 2014

(54) OPERATING METHOD AND OPERATING SYSTEM FOR A PCB DRILLING-MILLING MACHINE USING DIFFERENT MOTION CONTROL PRODUCTS

(71) Applicant: Delta Electro-optics (Wujiang) Ltd., Wujiang (CN)

(72) Inventors: Fujin Shang, Wujiang (CN); Liangyi Yen, Wujiang (CN); Yanlong Yang, Wujiang (CN); Yongjun Wu, Wujiang (CN)

(21) Appl. No.: 13/912,329

(22) Filed: Jun. 7, 2013

(30) Foreign Application Priority Data
Oct. 15, 2012 (CN) 201210387674.2

(51) Int. Cl. G05B 19/042

(52) U.S. Cl. CPC G05B 19/042
USPC 700/275

(57) ABSTRACT

The invention discloses an operating method and system for a PCB drilling-milling machine using different motion control products. The method comprises that a PCB drilling-milling machine runs a control module of a motion control product by running a drilling-milling module. The operating method further comprises: storing a control module of at least one motion control product in the PCB drilling-milling machine; inputting a selection information which is a code of a desired motion control product while running the drilling-milling module; and, the PCB drilling-milling machine matching the selection information with the code(s) of all the motion control product(s) stored during the step 1, and running the control module of the motion control product matched with the selection information. The invention makes the drilling-milling machine compatible with different motion control products via one drilling-milling module. It is convenient to update and replace hardware(s) of drilling-milling machines and reduce the development cycle.

### CROSS REFERENCE TO RELATED APPLICATIONS

This non-provisional application claims the benefit of Chinese Patent Application No. 201210387674.2, titled “OPERATING METHOD AND OPERATING SYSTEM FOR A PCB DRILLING-MILLING MACHINE USING DIFFERENT MOTION CONTROL PRODUCTS”, filed on Oct. 15, 2012, the entire contents of which are incorporated by reference herein, for all purposes.

Some references, if any, which may include patents, patent applications and various publications, may be cited and discussed in the description of this invention. The citation and/or discussion of such references, if any, is provided merely to clarify the description of the present invention and is not an admission that any such reference is “prior art” to the invention described herein. All references listed, cited and/or discussed in this specification are incorporated herein by reference in their entireties and to the same extent as if each reference was individually incorporated by reference.

### FIELD OF THE INVENTION

The present application relates to a control field of a PCB drilling-milling machine, more particularly relates to an operating method and an operating system for a PCB drilling-milling machine which uses different motion control products.

### BACKGROUND

During the process of rapid social development, social life of human being is more and more abundant and social production of human being is more and more efficient. Various life electronic products, such as a network television, an energy-saving air conditioner, a car audio, a smart phone, a tablet PC, and the like, and various production electronic products, such as an inverter, a human-machine interface, a programmable logic controller, a servo amplifier, and the like, play a huge role. As a printed circuit board acts as a function carrier for these electronic products, industrial development of the printed circuit board is particularly important.

While China becomes a large manufacturing country in electronic products, PCB productivity of the world is also transferred to China. According to statistics from the CPCA, not only do domestic PCB manufacturers accelerate to increase the productivity of PCB, but also foreign manufacturers also accelerate to transfer the productivity to China and increase the productivity in China. PCB industry investment in China is hot, however, there is a fact which can not be ignored, that is although China has become a large PCB manufacturing country in the world, the development on industries of key relevant devices, such as apparatus, instruments, and the like, which are necessary for production of PCB, is poor. Therefore, fast and efficient development on the equipment for PCB drilling-milling industry will provide important support for the growth of PCB industry in China.

PCB drilling-milling is an important process in PCB manufacturing industry chain. Most of manufacturers apply automatic PCB drilling-milling machine for improving efficiency and quality of the process of drilling-milling. The automatic PCB drilling-milling machine comprises an industrial computer and a drilling-milling hardware. The industrial computer runs a drilling-milling module, i.e. drilling-milling software. That is to say, the industrial computer controls the automatic operation of the drilling-milling hardware by running the drilling-milling module. The drilling-milling hardware is an actuating mechanism which comprises a motion control product and a control module of the motion control product. The motion control product comprises hardware units, such as a motor and its corresponding module, a motion control card including the control module, a servo amplifier, an input-output module, a pulse module, a hand wheel module, etc. The control module is a SDK software package for example. The motion control product may be driven to operate by the control module of the motion control card.

In prior art, different drilling-milling hardwares may comprise different motion control products corresponding to different control modules, and the different control modules need to be called by different drilling-milling modules. For that reason, if the drilling-milling hardware employs products from different manufacturers in a drilling-milling machine, the industrial computer may need to employ different drilling-milling modules correspondingly. FIG. 1 is a structural diagram showing the control relationship of a PCB drilling-milling machine in prior art.

When a drilling-milling hardware uses a product from a manufacturer A, then the industrial computer needs to employ a corresponding drilling-milling software A′ to call a SDK software package of the product of the manufacturer A. When the drilling-milling hardware uses a product from a manufacturer B, then the industrial computer needs to employ a corresponding drilling-milling software B′ to call a SDK software package of the product of the manufacturer B. When the drilling-milling hardware uses a product from a manufacturer C, then the industrial computer needs to employ a corresponding drilling-milling software C′ to call a SDK software package of the product of the manufacturer C.

Thus, in prior art, a drilling-milling software run by an industrial computer needs to correspond to a control module of a motion control product employed by a drilling-milling hardware in an one-to-one manner, and it is impossible for one drilling-milling software to call all the drilling-milling hardwares. Due to that, the drilling-milling software or its versions applied by an industrial computer are too excessive to manage and control. Once the PCB drilling-milling machine employs a new drilling-milling hardware, it is necessary to re-develop drilling-milling software to match with the new drilling-milling hardware. Furthermore, the functions of the software to be re-developed for calling a SDK software package of the new drilling-milling hardware comprise system initialization, motor returning to zero-point, digital input and output, pulse output, hand wheel signal input, system status reading, system turning off, etc. All of these need to be rewritten according to the new SDK software package, and that results in the rate of reuse the software code low and make the development cycle longer. In addition, when the drilling-milling hardware needs to be updated, its corresponding SDK software package would be updated subsequently, and then the corresponding drilling-milling software would have to be performed modification for its source code accordingly. The modified source code will be re-compiled to re-generate an executable file which will be distributed to end customer(s) finally. Thus, it is complex process that the whole software of the machine needs to be replaced when the hardware is updated.

### SUMMARY OF THE INVENTION

The summary is provided to introduce a selection of concepts in a simplified form that are further described below in the Detailed Description. This summary is not intended to identify key features or essential features of the claimed subject matter, nor is it intended to be used to limit the scope of the claimed subject matter.

A technical problem to be resolved in the invention is to provide an operating method and an operating system, which make a drilling-milling machine compatible with different motion control products via one drilling-milling module. Thereby, it is not necessary to re-develop a drilling-milling module when a motion control product is replaced.

Furthermore, it may make replacement of a drilling-milling hardware more simply, conveniently, and rapidly.

Furthermore, it may save from the modification of the drilling-milling module when hardware of the drilling-milling machine is updated. Hence the development cycle is reduced.

Embodiments of the present application contemplate an operating method for a PCB drilling-milling machine using different motion control products. The operating method comprises a step that a PCB drilling-milling machine runs a control module of a motion control product by running a drilling-milling module, and the operating method further comprises:

step 1, storing a control module of at least one motion control product in the PCB drilling-milling machine;

step 2, inputting a selection information, which is a code of a desired motion control product while running the drilling-milling module of the PCB drilling-milling machine; and

step 3, matching the selection information with code(s) of all of the motion control product(s) stored during the step 1, and running the control module of the motion control product matched with the selection information by the PCB drilling-milling machine.

Corresponding to the operating method for the PCB drilling-milling machine using different motion control products described above, embodiments of the present application further contemplates an operating system for a PCB drilling-milling machine using different motion control products. The operating system further comprises:

a storing unit for storing a control module of at least one motion control product;

an input unit for inputting a selection information, which is a code of a desired motion control product, while running a drilling-milling module of the PCB drilling-milling machine; and

a matching-running unit for matching the selection information with code(s) of all of the motion control product(s) stored in the storing unit, and running the control module of the motion control product matched with the selection information.

The present application makes the drilling-milling machine compatible with different motion control products via one drilling-milling module. It is convenient to update and replace hardware of the drilling-milling machine and development cycle is reduced.

### BRIEF DESCRIPTION OF THE DRAWINGS

FIG. 1 depicts a structural diagram of the control relationship of a PCB drilling-milling machine in prior art;

FIG. 2 depicts is flowchart schematic diagram of an operating method of a PCB drilling-milling machine using different motion control products according to an example of the invention;

FIG. 3 is a schematic diagram depicting the display of a name of each drilling-milling hardwares on a human-computer interface;

FIG. 4 depicts a structural schematic diagram of a PCB drilling-milling machine according to an example of the invention;

FIG. 5 depicts a schematic diagram of an operating system of the PCB drilling-milling machine using different motion control products according to an example of the invention.

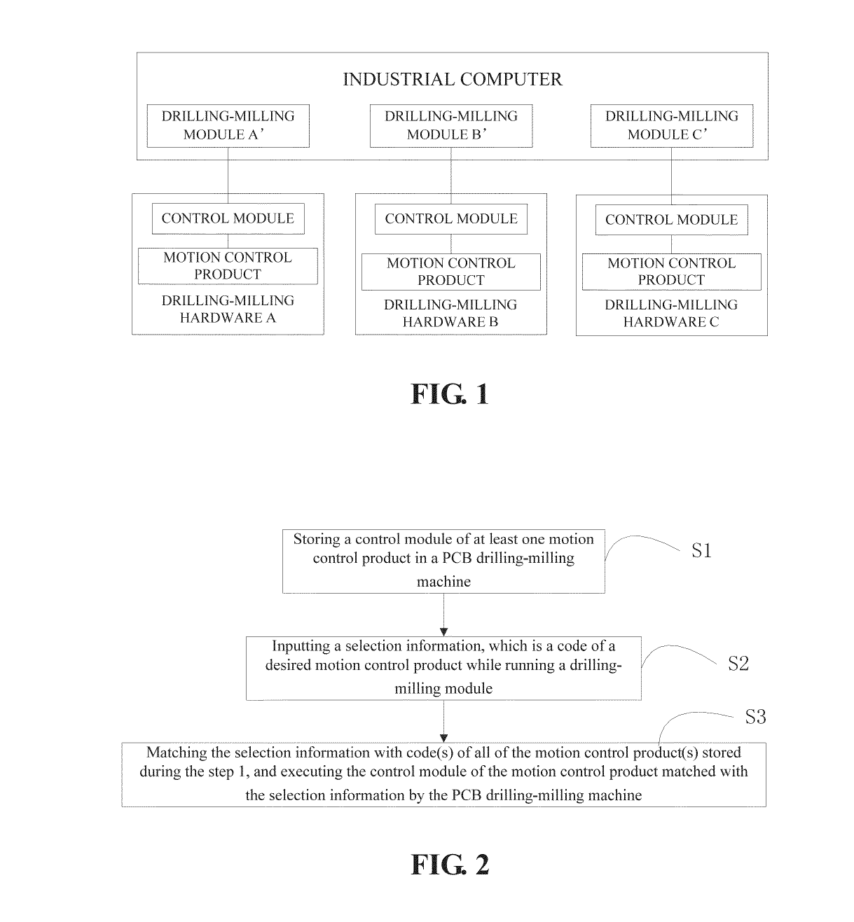

### DESCRIPTION OF THE PREFERRED EMBODIMENTS

The present application discloses an operating method for a PCB drilling-milling machine using different motion control products. The method could make a drilling-milling machine compatible with motion control products from different manufacturers via one drilling-milling module. According to embodiments of the invention, when running a drilling-milling module, the industrial computer calls a compatible module and calls a control module of a motion control product of a desired drilling-milling hardware via the compatible module so as to drive the motion control product to operate.

Referring to FIG. 2, a flowchart schematic diagram depicts an operating method of a PCB drilling-milling machine using different motion control products according to an example of the invention.

In step 1, storing a control module of at least one motion control product in a PCB drilling-milling machine;

In step 2, inputting a selection information, which is a code of a desired motion control product while running a drilling-milling module of the PCB drilling-milling machine; and

In step 3, matching the selection information with the code(s) of all of the motion control product(s) stored during the step 1, and running the control module of the motion control product matched with the selection information by the PCB drilling-milling machine.

Specifically, the compatible module is a .dll file (Dynamic Link Library file), for example, a MC.dll file, and the drilling-milling module is a drilling-milling module.exe file. The MC.dll is stored in a directory where the drilling-milling module.exe is present. A MC.h (header file) and a MC.lib (import library file) which correspond to the MC.dll1 are both stored under an engineering folder of the drilling-milling module.exe, and the MC.h is contained into a source code file for a primary motion control for supporting the normal operation of the MC.dll. When the industrial computer runs the drilling-milling module.exe, the drilling-milling module.exe will automatically call the MC.dll.

With respect to a drilling-milling hardware to be compatible, a control module of a motion control product of the drilling-milling hardware is stored in a storage space of a PCB drilling-milling machine in advance. The control module is also a .dll file. For instance, a drilling-milling hardware A has a A.dll that may drive a motion control product of the drilling-milling hardware A to operate. Similarly, a drilling-milling hardware B has a B.dll, and a drilling-milling hardware C has a C.dll. The control modules of the drilling-milling hardwares A, B, and C are pre-stored under the directory where the drilling-milling module.exe is present. In addition, a header file (A.h) and an import library file (A.lib) which correspond to the A.dll are both stored under the engineering folder of the drilling-milling module.exe. A B.h file, a C.h file, a B.lib file, and C.lib file are also stored under the engineering folder of the drilling-milling module.exe, and the A.h, the B.h, the C.h may be further contained into the source code file for a primary motion control.

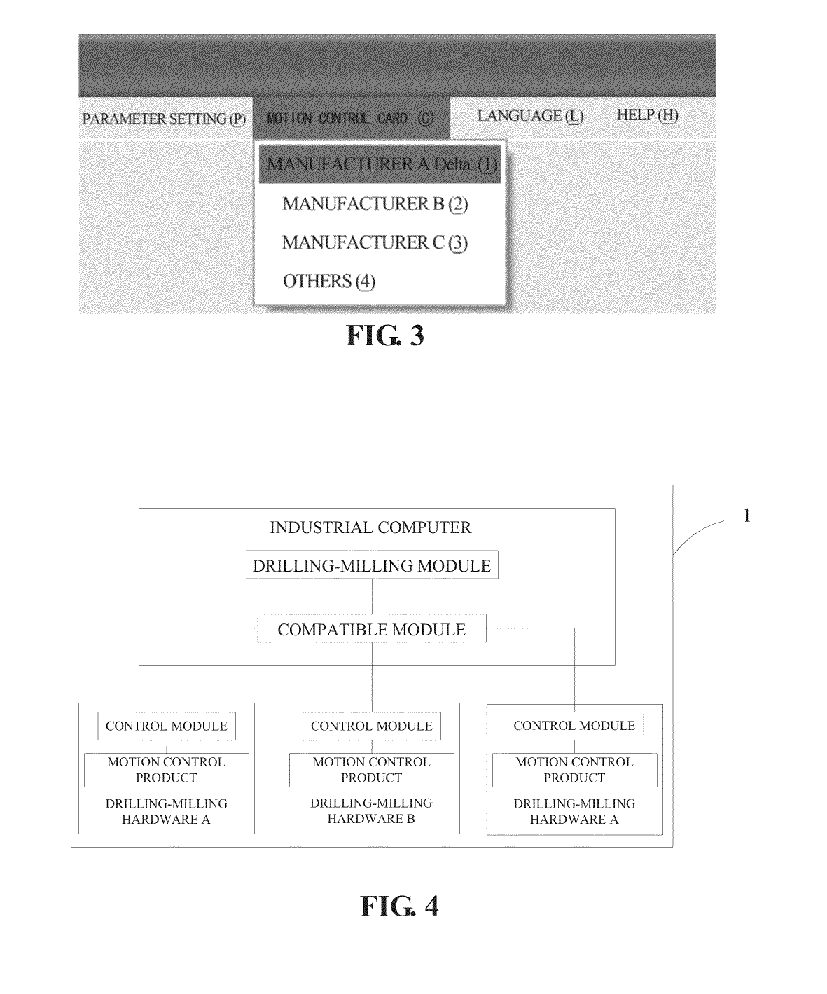

While running the drilling-milling module.exe, code(s) of all of the motion control product(s) stored at present may be displayed via a human-computer interface. For example, as shown in FIG. 3, a schematic diagram depicts that the names of various drilling-milling hardwares are displayed on the human-computer interface. FIG. 4 depicts a structural schematic diagram of a PCB drilling-milling machine 1 according to an example of the invention.

As shown in FIG. 3, a user may perform selection on the human-computer interface. The human-computer interface comprises a motion control card option, which has a plurality of codes. Each of the codes corresponds to a name of a drilling-milling hardware, and the user may select one of the codes to generate the selection information.

The drilling-milling module.exe automatically calls the MC.dll, and the selection information is transferred into the compatible module, MC.dll. Then, the compatible module compares the selection information with the codes of all of the drilling-milling hardwares stored in the drilling-milling machine sequentially to perform a matching judgment. Once the selection information is believed to be the same to one of the stored codes, the PCB drilling-milling machine will call a control module of a motion control product of a drilling-milling hardware corresponding to the one code.

The control module of each of the motion control products comprises control instructions, for example, motor returning to origin of a Z-phase, system initialization, digital input and output, pulse output, hand wheel signal input, system status read and/or system turning off, and the like. It is possible to realize the driving of the motion control products as desired.

When the drilling-milling machine replaces a drilling-milling hardware, the only thing needed to do is to store a control module of a new motion control product in the drilling-milling machine, and perform the action of selection on a code of a drilling-milling hardware as desired via the interface shown in FIG. 3. At the mean time, it is possible to communicate with a drilling-milling hardware which is used at present and control its operation by the previously running drilling-milling module of the drilling-milling machine. That is to say, it may control drilling-milling hardwares produced by all the manufacturers by only one drilling-milling module via the compatible module disclosed in the embodiments of the invention. Furthermore, the process of replacing a drilling-milling is simple, and the version of the drilling-milling module is single, thus and maintenance is convenient. When a drilling-milling hardware is updated, a control module (SDK software package) will be updated correspondingly. At this time, it is not necessary to perform tasks on the drilling-milling module by using the technical solution(s) of the present application, such as modifying source code, re-compiling, regenerating an executable file, and the like, therefore, the process of update is convenient and rapid, and cycle for development is short.

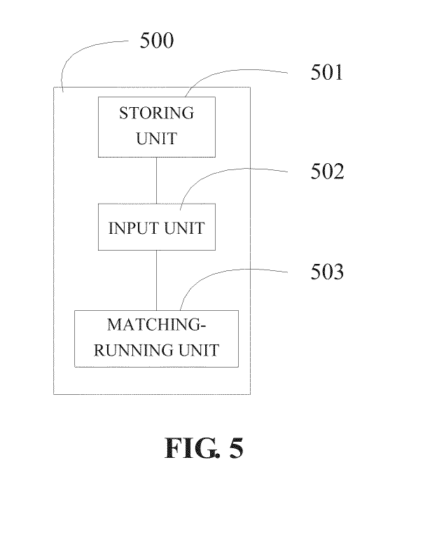

Corresponding to the operating method of the PCB drilling-milling machine using different motion control products as described above, the embodiments of the invention further disclose an operating system 500 of a PCB drilling-milling machine using different motion control products, as shown in FIG. 5. The system further comprises:

a storing unit 501, is configured to store a control module of at least one motion control product;

an input unit 502 is configured to input a selection information, which is a code of a desired motion control product while running a drilling-milling module of the PCB drilling-milling machine;

a matching-running unit 503, is configured to match the selection information with code(s) of all of the motion control product(s) stored in the storing unit and running the control module of the motion control product matched with the selection information.

The input unit is further configured to comprise: a unit, which is configured to display the code(s) of all of the motion control product(s) stored at present via a human-computer interface and input the selection information by selecting the code of the desired motion control product from the code(s) displayed on the human-computer interface.

The matching-running unit is a compatible module, i.e. the.dll file described above.

What is claimed is:

1. An operating method for a PCB drilling-milling machine using different motion control products, comprising a step that a PCB drilling-milling machine runs a control module of a motion control product by running a drilling-milling module, wherein the method further comprises:
step 1, storing a control module of at least one motion control product in the PCB drilling-milling machine;
step 2, inputting a selection information which is a code of a desired motion control product, while running the drilling-milling module; and
step 3, matching the selection information with the code(s) of all of the motion control product(s) stored during the step 1, and running the control module of the motion control product matched with the selection information by the PCB drilling-milling machine.

2. The operating method in accordance with claim 1, wherein the motion control product comprises a motor.

3. The operating method in accordance with claim 1, wherein the step 2 further comprises:
displaying the code(s) of all of the motion control product(s) stored at present via a human-computer interface, and inputting the selection information by selecting the code of the desired motion control product from the code(s) displayed on the human-computer interface.

4. An operating system for a PCB drilling-milling machine using different motion control products, wherein the system further comprises:
a storing unit for storing a control module of at least one motion control product;
an input unit for inputting a selection information, which is a code of a desired motion control product, while running a drilling-milling module of the PCB drilling-milling machine; and
a matching-running unit for matching the selection information with code(s) of all of the motion control product(s) stored in the storing unit, and running the control module of the motion control product matched with the selection information.

5. The operating system in accordance with claim 4, wherein the input unit further comprises:
a unit for displaying the code(s) of all of the motion control product(s) stored at present via a human-computer interface and input the selection information by selecting the code of the desired motion control product from the code(s) displayed on the human-computer interface.

6. The operating system in accordance with claim 4, wherein the matching-running unit is a compatible module and the compatible module is a .dll file.
